(19) United States
(12) Patent Application Publication
(10) Pub. No.: US 2010/0072912 A1
(43) Pub. Date: Mar. 25, 2010

(54) Side-Type Backlight Module and Operating Method Thereof

(75) Inventors: Yu-Chang Wu, Hsin-Chu (TW); Hsin-Wu Lin, Hsin-Chu (TW); Ya-Hua Ko, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/501,713

(22) Filed: Jul. 13, 2009

(30) Foreign Application Priority Data
Sep. 25, 2008 (TW) 97136941

(51) Int. Cl. H05B 41/24; F21V 7/04

(52) U.S. Cl. 315/287; 362/612; 362/613

(57) ABSTRACT

A side-type backlight module includes a light guide plate and a plurality of light emitting diode (LED) sources. The light guide plate includes a side. The LED sources are disposed on the side, in which two successive LED sources are spaced by a pitch. It is varied to arrange each pitch between two successive LED sources. Moreover, a method for operating the side-type backlight module is disclosed in the specification.

### RELATED APPLICATIONS

This application claims priority to Taiwan Application Serial Number 97136941, filed Sep. 25, 2008, which is herein incorporated by reference.

### BACKGROUND

1. Field of Invention

The present invention relates to a backlight module and an operating method thereof. More particularly, the present invention relates to a side-type backlight module and an operating method thereof.

2. Description of Related Art

The side-type backlight module can direct light from its lateral faces to the top surface for providing uniform light. The back light source of the side-type backlight module may include cold cathode fluorescent lamps (CCFL), light-emitting diode (LED) or the like. LED has gradually replaced CCFL in display field, because they are very small, lower power consumption, long working life, lower driving voltage, stronger shock resistance and so forth.

In general, the LED light sources are disposed on the lateral face, and have equal pitches between each LED light sources.

However, the equal pitches among the LED light sources cause a difference of power density and heat dissipation capability in different places of the light guide plate, which results in unbalanced temperature distribution or high temperature gathered at some places of the light guide plate. Thus, the light density of the backlight module will not uniform, and the light guide plate may be warped; therefore, the reliability of the side-type backlight module is reduced.

In view of the foregoing, there is a need in the related field to provide a suitable side-type backlight module and a method for operating the side-type backlight module.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present invention is directed to a side-type backlight module.

According to one embodiment of the present invention, the side-type backlight module comprises a light guide plate and a plurality of LED light sources. The light guide plate comprises a lateral face. The LED light sources are disposed on the lateral face, wherein every two adjacent LED sources are spaced by a pitch and the pitches between each two LED light sources are difference. Thus, the problem of the unbalanced temperature distribution is solved, thereby the quality of light is unaffected, and the appearance of the warped light guide plate is prevented.

According to another embodiment of the present invention, the side-type backlight module comprises a light guide plate, a plurality of first LED light sources, a plurality of second LED light sources, a plurality of third LED light sources and a plurality of fourth LED light sources. The light guide plate comprising a first lateral face, a second lateral face, a third lateral face and a fourth lateral face, where the first lateral face is opposite to the second lateral face, and the third lateral face is opposite to the fourth lateral face; the first lateral face is connected with the third and fourth lateral faces, the second lateral face is connected with the third and fourth lateral faces. The first LED light sources are disposed on the first lateral face, wherein every two adjacent first LED sources are spaced by an first pitch, thereby a plurality of the first pitches are arranged among the first LED light sources, wherein at least one minimum first pitch of the first pitches is positioned nearest to a center of the first lateral face; the second LED light sources are disposed on the second lateral face, wherein every two adjacent second LED sources are spaced by a second pitch, thereby a plurality of the second pitches are arranged among the second LED light sources, wherein at least one minimum second pitch of the second pitches is positioned nearest to a center of the second lateral face; the third LED light sources disposed on the third lateral face, wherein every two adjacent third LED sources are spaced by an third pitch, thereby a plurality of the third pitches are arranged among the third LED light sources, wherein at least one minimum third pitch of the third pitches is positioned nearest to a center of the third lateral face; the fourth LED light sources disposed on the fourth lateral face, wherein every two adjacent fourth LED sources are spaced by an fourth pitch, thereby a plurality of the fourth pitches are arranged among the fourth LED light sources, wherein at least one minimum fourth pitch of the fourth pitches is positioned nearest to a center of the fourth lateral face. Thus, the problem of the unbalanced temperature distribution is solved, thereby the quality of light is unaffected, and the appearance of the warped light guide plate is prevented.

In another aspect, the present invention is directed to a method for operating a side-type backlight module.

According to another embodiment of the present invention, the method for operating the side-type backlight module is accomplished, wherein the side-type backlight module comprises a light guide plate comprising a lateral face and a plurality of LED light sources disposed on the lateral face. The method is performed to drive the LED light sources in such a way that powers of the LED light source are varied. Thus, the problem of the unbalanced temperature distribution is solved, thereby the quality of light is unaffected, and the appearance of the warped light guide plate is prevented.

According to another embodiment of the present invention, the method for operating the side-type backlight module is accomplished, wherein the side-type backlight module comprises a light guide plate, a plurality of first LED light sources, a plurality of second LED light sources, a plurality of third LED light sources and a plurality of fourth LED light sources. The light guide plate comprises a first lateral face, a second lateral face, a third lateral face and a fourth lateral face, where the first lateral face is opposite to the second lateral face, and the third lateral face is opposite to the fourth lateral face; the first lateral face is connected with the third and fourth lateral faces, and the second lateral face is connected with the third and fourth lateral faces. The first LED light sources are disposed on the first lateral face; the second LED light sources are disposed on the second lateral face; the third LED light sources are disposed on the third lateral face; the fourth LED light sources are disposed on the fourth lateral face. The method is performed to drive the first, second, third and fourth LED light sources in such a way that powers of first, second, third and fourth LED light sources are varied. Thus, the problem of the unbalanced temperature distribution is solved, thereby the quality of light is unaffected, and the appearance of the warped light guide plate is prevented.

### BRIEF DESCRIPTION OF THE DRAWINGS

The present description will be better understood from the following detailed description read in light of the accompanying drawings, wherein:

FIG. 1 is a schematic diagram showing a side-type backlight module according to an embodiment of the invention;

FIG. 2 is a schematic diagram showing a side-type backlight module according to another embodiment of the invention;

FIG. 3 is a schematic diagram showing a side-type backlight module according to another embodiment of the invention

FIG. 4 is a schematic diagram showing a method for operating a side-type backlight module according to another embodiment of the invention; and

FIG. 5 is a schematic diagram showing a method for operating a side-type backlight module according to another embodiment of the invention.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

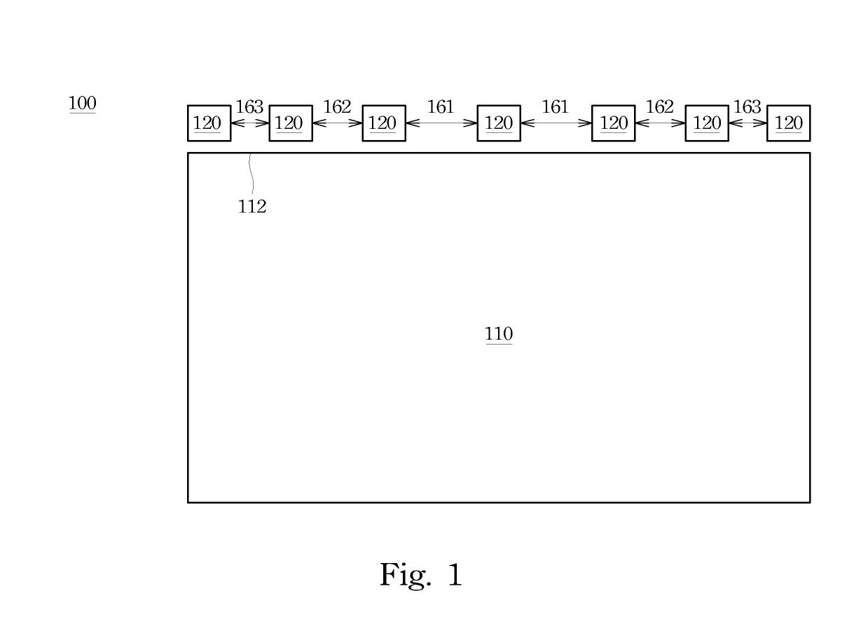

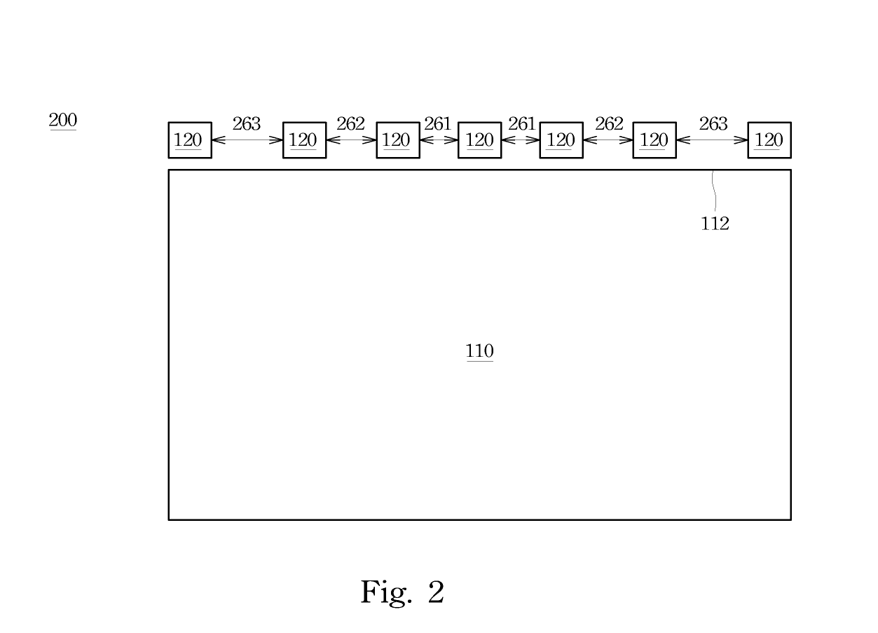

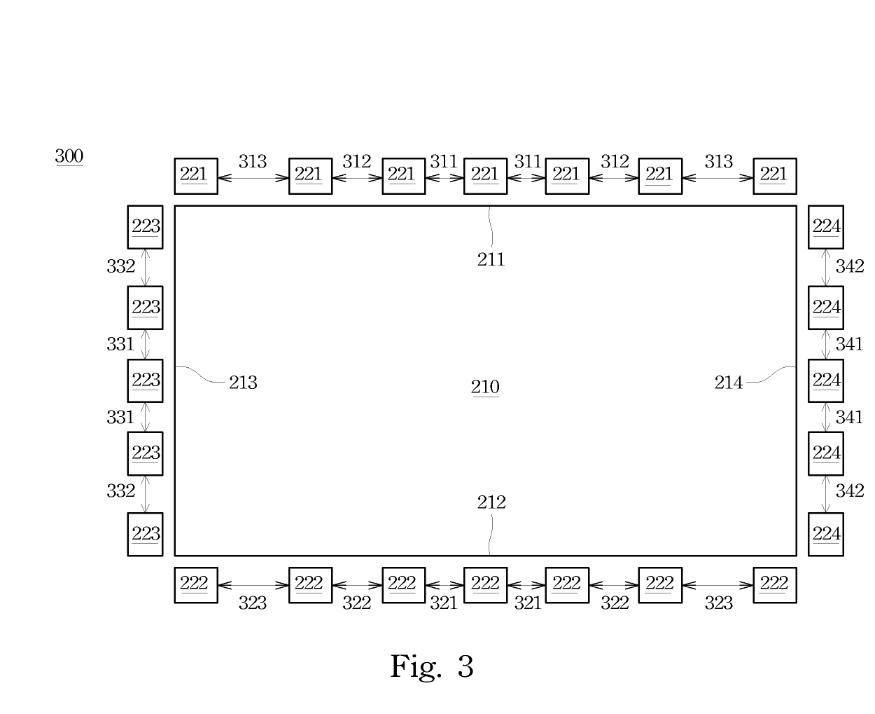

In one aspect, the present invention is directed to a side-type backlight module. The side-type backlight module may be easily inserted into displays and may be applicable or readily adaptable to all technologies. Herewith a side-type backlight module is illustrated by reference to the following descriptions considered in FIG. 1, FIG. 2 and FIG. 3.

In the side-type backlight module, a plurality of LED light sources may be disposed on one lateral face of the light guide plate in a longitudinal direction. In general, every two adjacent LED sources are spaced by a pitch, and the pitches arranged among the LED light sources are the same. Thus, the temperature distribution of the lateral face of the light guide plate is unbalanced.

For the foregoing reasons, please refer to FIG. 1. FIG. 1 is a schematic diagram showing a side-type backlight module according to an embodiment of the invention. In FIG. 1, the side-type backlight module 100 comprises a light guide plate 110 and a plurality of LED light sources 120. The light guide plate 110 comprises a lateral face 112. The LED light sources 120 are disposed on the lateral face 112 in a longitudinal direction; every two adjacent LED sources 120 are spaced by a pitch, and the pitches 161,162 and 163 arranged among the LED light sources 120 are varied.

Accordingly, the varied pitches 161,162 and 163 are arranged among the LED light sources 120 for preventing the unbalanced temperature distribution of the lateral face 112 of the light guide plate 110.

In FIG. 1, at least one maximum pitch 161 of the pitches 161,162 and 163 is positioned nearest to a center of the lateral face 112. Thus, a state of high temperature of the center of the lateral face 112 is avoided.

In FIG. 1, one or two minimum pitches 163 of the pitches 161,162 and 163 are positioned nearest to margins of the lateral face 112. Thus, it is prevented that the temperature of the margins of the lateral face 112 is lower than the temperature of the center of the lateral face 112.

In FIG. 1, the pitches 161,162 and 163 are gradually decreased from the center to the margins of the lateral face 112 of the light guide plate 110. In other words, the pitches 161 are greater than the pitches 162, and the pitches 162 are greater than the pitches 163. Thus, the temperature distribution of the lateral face 112 of the light guide plate 110 is uniform.

In FIG. 1, power outputs of the LED light sources 120 are substantially equal; alternatively, power outputs of the LED light sources 120 are varied, which may be used as appropriate for a given application.

Please refer to FIG. 2. FIG. 2 is a schematic diagram showing a side-type backlight module according to another embodiment of the invention. In FIG. 2, the side-type backlight module 200 comprises a light guide plate 110 and a plurality of LED light sources 120. The light guide plate 110 comprises a lateral face 112. The LED light sources 120 are disposed on the lateral face 112 in a longitudinal direction; every two adjacent LED sources 120 are spaced by a pitch, and the pitches 261,262 and 263 arranged among the LED light sources 120 are varied.

Accordingly, the varied pitches 261,262 and 263 are arranged among the LED light sources 120, so as to prevent the unbalanced temperature distribution of the lateral face 112 of the light guide plate 110.

In FIG. 2, at least one minimum pitch 261 of the pitches 261,262 and 263 is positioned nearest to a center of the lateral face 112. Thus, it is prevented that the temperature of the center of the lateral face 112 is lower than the temperature of margins of the lateral face 112.

In FIG. 2, one or two maximum pitches 263 of the pitches 261,262 and 263 are positioned nearest to margins of the lateral face 112. Thus, a state of high temperature of the margins of the lateral face 112 is avoided.

In FIG. 2, the pitches 261,262 and 263 are gradually increased from the center to the margins of the lateral face 112 of the light guide plate 110. In other words, the pitches 263 are greater than the pitches 262, and the pitches 262 are greater than the pitches 261. Thus, the temperature distribution of the lateral face 112 of the light guide plate 110 is uniform.

In FIG. 2, power outputs of the LED light sources 120 may be varied, so that the arrangement of the LED light sources 120 can be correlated with the varied power outputs of the LED light sources 120, whereby the temperature distribution of the lateral face 112 of the light guide plate 110 is uniform.

Please refer to FIG. 3. FIG. 3 is a schematic diagram showing a side-type backlight module according to another embodiment of the invention. In FIG. 3, the side-type backlight module 300 comprises a light guide plate 210 and a plurality of LED light sources 221,222,223 and 224.

The light guide plate 210 comprises a first lateral face 211, a second lateral face 212, a third lateral face 213 and a fourth lateral face 214. The first lateral face 211 is opposite to the second lateral face 212; the third lateral face 213 is opposite to the fourth lateral face 214. The first lateral face 211 is connected with the third and fourth lateral faces 212 and 214; the second lateral face 212 is connected with the third and fourth lateral faces 213 and 214.

In FIG. 3, the first LED light sources 221 are disposed on the first lateral face 211; every two adjacent first LED sources 221 are spaced by a first pitch, thereby a plurality of the first pitches 311,312 and 313 are arranged among the first LED light sources 221, wherein at least one minimum first pitch 311 of the first pitches 311,312 and 313 is positioned nearest to a center of the first lateral face 211. The second LED light sources 222 are disposed on the second lateral face 212; every two adjacent second LED sources 222 are spaced by a second pitch, thereby a plurality of the second pitches 321,322 and 323 are arranged among the second LED light sources 222, wherein at least one minimum second pitch 321 of the second pitches 321,322 and 323 is positioned nearest to a center of the second lateral face 321. The third LED light sources 223 are disposed on the third lateral face 213; every two adjacent third LED sources 223 are spaced by a third pitch, thereby a plurality of the third pitches 331 and 332 are arranged among the third LED light sources 223, wherein at least one minimum third pitch 341 of the third pitches 341 and 342 is positioned nearest to a center of the third lateral face 214. Thus, it is prevented that the temperature of the center of each light guide plate is lower than the temperature of margins of the light guide plate.

In FIG. 3, the minimum first pitch 311 is equal to the minimum second pitch 321 in length, and the minimum third pitch 331 is equal to the minimum fourth pitch 341 in length. Thus, the symmetrical temperature distribution of each pair of opposing lateral faces of the light guide plate 210 is accomplished.

In FIG. 3, one or two maximum first pitches 313 of the first pitches 311,312 and 313 are positioned nearest to margins of the first lateral face 211; one or two maximum second pitches 323 of the second pitches 321,322 and 323 are positioned nearest to margins of the second lateral face 212; one or two maximum third pitches 332 of the third pitches 331 and 332 are positioned nearest to margins of the third lateral face 213; one or two maximum fourth pitches 241 of the fourth pitches 341 and 342 are positioned nearest to margins of the fourth lateral face 214. Thus, a state of high temperature of the margins of each lateral face of the light guide plate 210 is avoided.

In FIG. 3, the maximum first pitches 313 are equal to the maximum second pitches 323 in length, and the maximum third pitches 332 are equal to the maximum fourth pitches 342 in length. Thus, the symmetrical temperature distribution of each pair of opposing lateral faces of the light guide plate 110 is accomplished.

In FIG. 3, the first pitches 311,312 and 313 are gradually increased from the center to the margins of the first lateral face 211; the second pitches 321,322 and 323 are gradually increased from the center to the margins of the second lateral face 212; the third pitches 331 and 332 are gradually increased from the center to the margins of the third lateral face 213; the fourth pitches 341 and 342 are gradually increased from the center to the margins of the fourth lateral face 214. Thus, the temperature distribution of each lateral face of the light guide plate 210 is uniform.

In FIG. 3, power outputs of the first, second, third and fourth LED light sources 221,222,223 and 224 are substantially equal; alternatively, power outputs of the LED light sources 221,222,223 and 224 are varied, which may be used as appropriate for a given application.

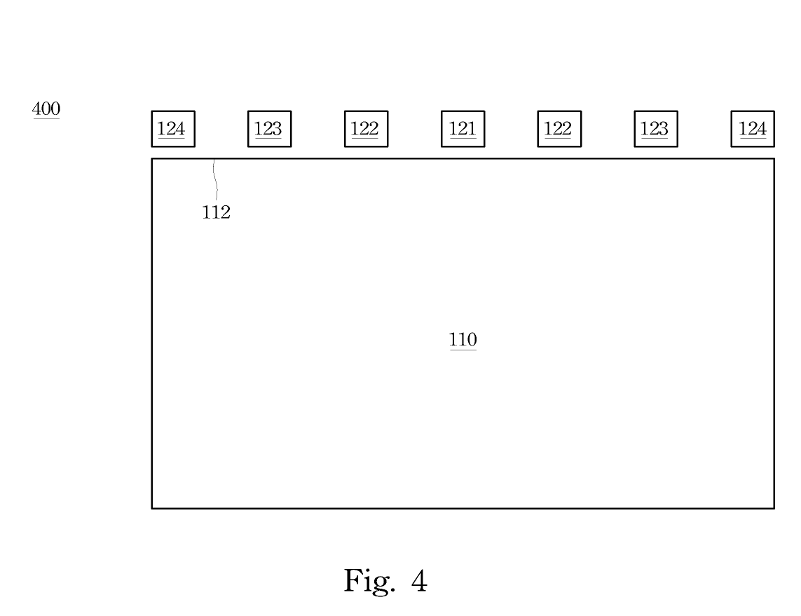

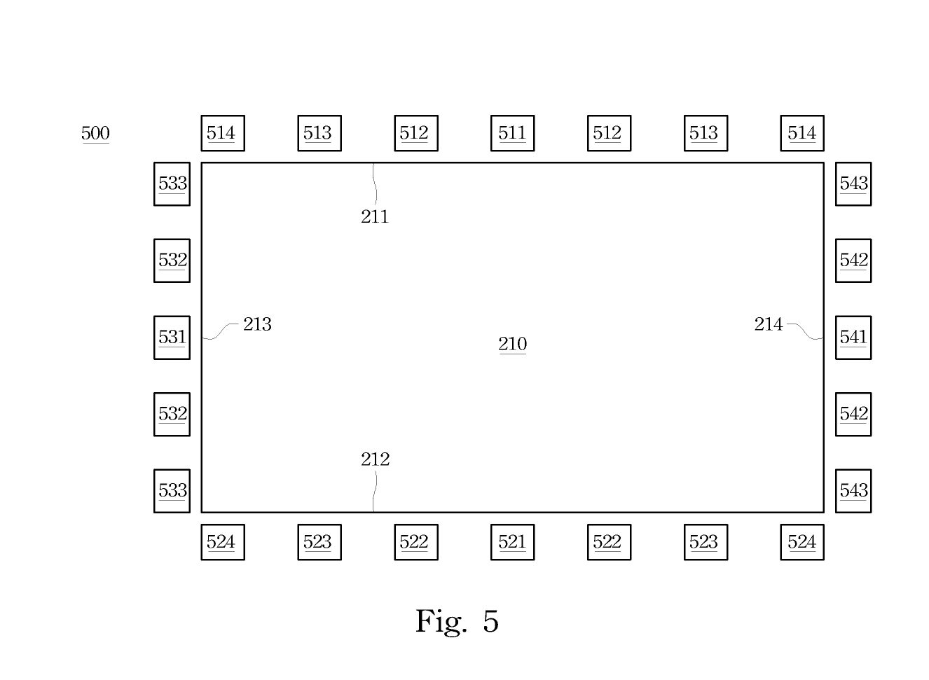

In another aspect, the present invention is directed to a method for operating a side-type backlight module. The method may be easily applied in displays and may be applicable or readily adaptable to all technologies. Herewith one or more methods for operating the side-type backlight module is illustrated by reference to the following description considered in FIG. 4 and FIG. 5.

Please refer to FIG. 4. FIG. 4 is a schematic diagram showing a method for operating a side-type backlight module according to another embodiment of the invention. In FIG. 4, the side-type backlight module 400 comprises a light guide plate 110 comprises a lateral face 112 and a plurality of LED light sources 121,122,123 and 124. The LED light sources 121,122,123 and 124 are disposed on the lateral face 112. The method is performed to drive the LED light sources 121,122,123 and 124 in such a way that powers of the LED light source 121,122,123 and 124 are varied, so as to prevent the unbalanced temperature distribution of the lateral face 112 of the light guide plate 110.

For a more complete understanding of the method for driving the side-type backlight module 400, the first and second embodiments are illustrated by reference to the following description considered in FIG. 4 In the first embodiment, a plurality of adjustable currents are generated by means of analog modulation, and the adjustable currents are inputted into the LED light sources 121,122,123 and 124 respectively, wherein at least one light source 121 of the LED light sources 121,122,123 and 124 positioned nearest to a center of the lateral face 112 receives a minimum current of the adjustable currents, so as to prevent power consumption gathered at the center of the lateral face 112 of the light guide plate 110. Thus, a state of high temperature of the center of the lateral face 112 is avoided.

Moreover, at least one LED light sources 124 positioned nearest to margins of the lateral face 112 receives at least one maximum current of the adjustable currents. Thus, it is prevented that the temperature of the margins of the lateral face 112 is lower than the temperature of the center of the lateral face 112.

Moreover, the adjustable currents received by the LED light sources 121,122,123 and 124 are gradually increased along a longitudinal direction from the center to the margins of the lateral face 112. In other words, the adjustable current received by the LED light sources 121 is lower than the adjustable current received by the LED light sources 122; the adjustable current received by the LED light sources 122 is lower than the adjustable current received by the LED light sources 123; the adjustable current received by the LED light sources 123 is lower than the adjustable current received by the LED light sources 124. Thus, power consumption and heat dissipation capacity of the lateral face 112 of the light guide plate 110 are balanced, so that the temperature distribution of the lateral face 112 of the light guide plate 110 is uniform.

In the second embodiment, a plurality of pulse currents is generated by means of pulse-width modulation, and the pulse currents is inputted into the LED light sources 121,122,123 and 124 respectively, peak values of the pulse currents being substantially equal, wherein each of the pulse currents has a duty cycle, and at least one LED light source 121 of the LED light sources 121,122,123 and 124 positioned nearest to the center of the lateral face 112 receives at least one of the pulse currents having a minimum duty cycle. Thus, a state of high temperature of the center of the lateral face 112 is avoided.

Moreover, at least one LED light sources 124 positioned nearest to the margins of the lateral face 112 receives at least one of the pulse currents having a maximum duty cycle. Thus, it is prevented that the temperature of the margins of the lateral face 112 is lower than the temperature of the center of the lateral face 112.

Moreover, the LED light sources 121,122,123 and 124 receives the pulse currents respectively, and the duty cycles of the pulse currents are gradually increased along a longitudinal direction from the center to the margins of the lateral face. In other words, the duty cycle of the pulse current of the LED light sources 121 is lower than the duty cycle of the pulse current of the LED light sources 122; the duty cycle of the pulse current of the LED light sources 122 is lower than the duty cycle of the pulse current of the LED light sources 123; the duty cycle of the pulse current of the LED light sources 123 is lower than the duty cycle of the pulse current of the LED light sources 124. Thus, power consumption and heat dissipation capacity of the lateral face 112 of the light guide plate 110 are balanced, so that the temperature distribution of the lateral face 112 of the light guide plate 110 is uniform.

Moreover, the pitches among the LED light sources 121,122,123 and 124 may be substantially equal; alternatively, the pitches among the LED light sources 121,122,123 and 124 may be varied, such as the arrangement of the pitches shown in FIG. 1 or in FIG. 2.

Please refer to FIG. 5. FIG. 5 is a schematic diagram showing a method for operating a side-type backlight module according to another embodiment of the invention. In FIG. 5, the side-type backlight module 500 comprises a light guide plate 210, a plurality of first LED light sources 511,512,513 and 514, a plurality of second LED light sources 521,522,523 and 524, a plurality of third LED light sources 531,532 and 533, and a plurality of fourth LED light sources 541,542 and 543.

The light guide plate 210 comprises a first lateral face 211, a second lateral face 212, a third lateral face 213 and a fourth lateral face 214. The first lateral face 211 is opposite to the second lateral face 212; the third lateral face 213 is opposite to the fourth lateral face 214. The first lateral face 211 is connected with the third and fourth lateral faces 213 and 214; the second lateral face 212 is connected with the third and fourth lateral faces 213 and 214.

The first LED light sources 511,512,513 and 514 are disposed on the first lateral face 211. The second LED light sources 521,522,523 and 524 disposed on the second lateral face 212. The third LED light sources 531,532 and 533 are disposed on the third lateral face 213. The fourth LED light sources 541,542 and 543 are disposed on the fourth lateral face 214.

The method for operating the side-type backlight module 500 is performed to driving the first, second, third and fourth LED light sources in such a way that powers of first, second, third and fourth LED light sources are varied.

For a more complete understanding of the method for driving the side-type backlight module 500, the third and fourth embodiments are illustrated by reference to the following description considered in FIG. 5.

In the third embodiment, a plurality of first adjustable currents are generated by means of analog modulation, and the first adjustable currents are inputted into the first LED light sources 511,512,513 and 514 respectively, wherein at least one first LED light source 511 of the first LED light sources 511,512,513 and 514 positioned nearest to a center of the first lateral face 211 receives a minimum current of the first adjustable currents; a plurality of second adjustable currents are generated by means of the analog modulation, and the second adjustable currents are inputted into the second LED light sources 521,522,523 and 524 respectively, wherein at least one second LED light source 521 of the second LED light sources 521,522,523 and 524 positioned nearest to a center of the second lateral face 212 receives a minimum current of the second adjustable currents; a plurality of third adjustable currents are generated by means of the analog modulation, and the third adjustable currents are inputted into the third LED light sources 531,532 and 533 respectively, wherein at least one third LED light source 531 of the third LED light sources 531,532 and 533 positioned nearest to a center of the third lateral face 213 receives a minimum current of the third adjustable currents; a plurality of fourth adjustable currents are generated by means of the analog modulation, and the fourth adjustable currents are inputted into the fourth LED light sources 541,542 and 543 respectively, wherein at least one fourth LED light source 541 of the fourth LED light sources 541,542 and 543 positioned nearest to a center of the fourth lateral face 214 receives a minimum current of the fourth adjustable currents. Thus, a state of high temperature of the center of each lateral face of the light guide plate 210 is avoided.

Moreover, at least one first LED light source 514 positioned nearest to margins of the first lateral face 211 receives at least one maximum current of the first adjustable currents; at least one second LED light source 524 positioned nearest to margins of the second lateral face 212 receives at least one maximum current of the second adjustable currents; at least one third LED light source 533 positioned nearest to margins of the third lateral face 213 receives at least one maximum current of the third adjustable currents; at least one fourth LED light source 543 positioned nearest to margins of the fourth lateral face 214 receives at least one maximum current of the fourth adjustable currents. Thus, it is prevented that the temperature of the margins of each lateral face of the light guide plate 210 is lower than the temperature of the center of each lateral face of the light guide plate 210.

Moreover, the first adjustable currents received by the first LED light sources 511,512,513 and 514 are gradually increased from the center to the margins of the first lateral face 211; the second adjustable currents received by the second LED light sources 521,522,523 and 524 are gradually increased from the center to the margins of the second lateral face 212; the third adjustable currents received by the third LED light sources 531,532 and 533 are gradually increased from the center to the margins of the third lateral face 213; the fourth adjustable currents received by the fourth LED light sources 541,542 and 543 are gradually increased from the center to the margins of the fourth lateral face 214. Thus, the temperature distribution of each lateral face of the light guide plate 210 is uniform.

In the fourth embodiment, a plurality of first pulse currents are generated by means of pulse-width modulation, and the first pulse currents are inputted into the first LED light sources 511,512,513 and 514 respectively, peak values of the first pulse currents being substantially equal, wherein each of the first pulse currents has a first duty cycle, and at least one first LED light source 511 of the first LED light sources 511,512,513 and 514 positioned nearest to the center of the first lateral face receives at least one of the first pulse currents having a minimum duty cycle of the first duty cycles; a plurality of second pulse currents are generated by means of the pulse-width modulation, and the second pulse currents are inputted into the second LED light sources 521,5122,523 and 524 respectively, peak values of the second pulse currents being substantially equal, wherein each of the second pulse currents has a second duty cycle, and at least one second LED light source 521 of the second LED light sources 521,5122,523 and 524 positioned nearest to the center of the second lateral face 212 receives at least one of the second pulse currents having a minimum duty cycle of the second duty cycles; a plurality of third pulse currents are generated by means of the pulse-width modulation, and the third pulse currents are inputted into the third LED light sources 531,532 and 533 respectively, peak values of the third pulse currents being substantially equal, wherein each of the third pulse currents has a third duty cycle, and at least one third LED light source 531 of the third LED light sources 531,532 and 533 positioned nearest to the center of the third lateral face 213 receives at least one of the third pulse currents having a minimum duty cycle of the third duty cycles; a plurality of fourth pulse currents are generated by means of the pulse-width modulation, and the fourth pulse currents are inputted into the fourth LED light sources 541,542 and 543 respectively, peak values of the fourth pulse currents being substantially equal, wherein each of the fourth pulse currents has a fourth duty cycle, and at least one fourth LED light source 541 of the fourth LED light sources 541,542 and 543 positioned nearest to the center of the fourth lateral face 214 receives at least one of the fourth pulse currents having a minimum duty cycle of the fourth duty cycles. Thus, a state of high temperature of the center of each lateral face of the light guide plate 210 is avoided.

Moreover, at least one first LED light source 514 positioned nearest to the margins of the first lateral face 211 receives at least one of the first pulse currents having a maximum duty cycle of the first duty cycles; at least one second LED light source 524 positioned nearest to the margins of the second lateral face 212 receives at least one of the second pulse currents having a maximum duty cycle of the second duty cycles; at least one third LED light source 533 positioned nearest to the margins of the third lateral face 213 receives at least one of the third pulse currents having a maximum duty cycle of the third duty cycles; at least one fourth LED light source 534 positioned nearest to the margins of the fourth lateral face 214 receives at least one of the fourth pulse currents having a maximum duty cycle of the fourth duty cycles. Thus, it is prevented that the temperature of the margins of each lateral face of the light guide plate 210 is lower than the temperature of the center of each lateral face of the light guide plate 210.

Moreover, the first LED light sources 511,512,513 and 514 receive the first pulse currents respectively, and the first duty cycles of the first pulse currents are gradually increased from the center to the margins of the first lateral face 211; the second LED light sources 521,522,523 and 524 receives the second pulse currents respectively, and the second duty cycles of the second pulse currents are gradually increased from the center to the margins of the second lateral face 212; the third LED light sources 531,532 and 533 receive the third pulse currents respectively, and the third duty cycles of the third pulse currents are gradually increased from the center to the margins of the third lateral face 213; the fourth LED light sources 541,542 and 543 receives the fourth pulse currents respectively, and the fourth duty cycles of the fourth pulse currents are gradually increased from the center to the margins of the fourth lateral face 214. Thus, the temperature distribution of each lateral face of the light guide plate 210 is uniform.

Moreover, the pitches among the LED light sources may be varied, such as the arrangement of the pitches shown in FIG. 3; alternatively, the pitches among the LED light sources may be substantially equal.

In an alternative embodiment, the pitches among the LED light sources are substantially equal. In this manner, the first LED light sources 511,512,513 and 514 receive the first pulse currents respectively, and the first duty cycles of the first pulse currents are gradually decreased from the center to the margins of the first lateral face 211; the second LED light sources 521,522,523 and 524 receives the second pulse currents respectively, and the second duty cycles of the second pulse currents are gradually decreased from the center to the margins of the second lateral face 212; the third LED light sources 531,532 and 533 receive the third pulse currents respectively, and the third duty cycles of the third pulse currents are gradually decreased from the center to the margins of the third lateral face 213; the fourth LED light sources 541,542 and 543 receives the fourth pulse currents respectively, and the fourth duty cycles of the fourth pulse currents are gradually decreased from the center to the margins of the fourth lateral face 214.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A side-type backlight module, comprising:
a light guide plate comprising a lateral face; and
a plurality of LED light sources disposed on the lateral face in a longitudinal direction, wherein every two adjacent LED sources are spaced by a pitch, and a plurality of the pitches arranged among the LED light sources are varied.

2. The side-type backlight module of claim 1, wherein at least one maximum pitch of the pitches is positioned nearest to a center of the lateral face.

3. The side-type backlight module of claim 2, wherein one or two minimum pitches of the pitches are positioned nearest to margins of the lateral face.

4. The side-type backlight module of claim 3, wherein the pitches are gradually decreased from the center to the margins of the lateral face.

5. The side-type backlight module of claim 3, wherein power outputs of the LED light sources are substantially equal.

6. The side-type backlight module of claim 1, wherein at least one minimum pitch of the pitches is positioned nearest to a center of the lateral face.

7. The side-type backlight module of claim 6, wherein one or two maximum pitches of the pitches are positioned nearest to margins of the lateral face.

8. The side-type backlight module of claim 7, wherein the pitches are gradually increased from the center to the margins of the lateral face.

9. A side-type backlight module, comprising:
a light guide plate comprising a first lateral face, a second lateral face, a third lateral face and a fourth lateral face, the first lateral face being opposite to the second lateral face, the third lateral face being opposite to the fourth lateral face, the first lateral face connected with the third and fourth lateral faces, the second lateral face connected with the third and fourth lateral faces;
a plurality of first LED light sources disposed on the first lateral face, wherein every two adjacent first LED sources are spaced by a first pitch, thereby a plurality of the first pitches are arranged among the first LED light sources, wherein at least one minimum first pitch of the first pitches is positioned nearest to a center of the first lateral face;
a plurality of second LED light sources disposed on the second lateral face, wherein every two adjacent second LED sources are spaced by a second pitch, thereby a plurality of the second pitches are arranged among the second LED light sources, wherein at least one minimum second pitch of the second pitches is positioned nearest to a center of the second lateral face;
a plurality of third LED light sources disposed on the third lateral face, wherein every two adjacent third LED sources are spaced by a third pitch, thereby a plurality of the third pitches are arranged among the third LED light sources, wherein at least one minimum third pitch of the third pitches is positioned nearest to a center of the third lateral face; and
a plurality of fourth LED light sources disposed on the fourth lateral face, wherein every two adjacent fourth LED sources are spaced by a fourth pitch, thereby a plurality of the fourth pitches are arranged among the fourth LED light sources, wherein at least one minimum fourth pitch of the fourth pitches is positioned nearest to a center of the fourth lateral face.

10. The side-type backlight module of claim 9, wherein the minimum first pitch is equal to the minimum second pitch in length, and the minimum third pitch is equal to the minimum fourth pitch in length.

11. The side-type backlight module of claim 9, wherein one or two maximum first pitches of the first pitches are positioned nearest to margins of the first lateral face; one or two maximum second pitches of the second pitches are positioned nearest to margins of the second lateral face; one or two maximum third pitches of the third pitches are positioned nearest to margins of the third lateral face; one or two maximum fourth pitches of the fourth pitches are positioned nearest to margins of the fourth lateral face.

12. The side-type backlight module of claim 11, wherein the maximum first pitches are equal to the maximum second pitches in length, and the maximum third pitches are equal to the maximum fourth pitches in length.

13. The side-type backlight module of claim 11, wherein the first pitches are gradually increased from the center to the margins of the first lateral face; the second pitches are gradually increased from the center to the margins of the second lateral face; the third pitches are gradually increased from the center to the margins of the third lateral face; the fourth pitches are gradually increased from the center to the margins of the fourth lateral face.

14. The side-type backlight module of claim 9, wherein power outputs of the first, second, third and fourth LED light sources are substantially equal.

15. A method for operating a side-type backlight module, the side-type backlight module comprising a light guide plate comprising a lateral face and a plurality of LED light sources disposed on the lateral face, the method comprising:
driving the LED light sources in such a way that powers of the LED light source are varied.

16. The method of claim 15, wherein driving the LED light sources comprises at least one of:
generating a plurality of adjustable currents by means of analog modulation, and inputting the adjustable currents into the LED light sources respectively, wherein at least one of the LED light sources positioned nearest to a center of the lateral face receives a minimum current of the adjustable currents; and
generating a plurality of pulse currents by means of pulse-width modulation, and inputting the pulse currents into the LED light sources respectively, peak values of the pulse currents being substantially equal, wherein each of the pulse currents has a duty cycle, and at least one of the LED light sources positioned nearest to the center of the lateral face receives at least one of the pulse currents having a minimum duty cycle.

17. The method of claim 16, wherein at least one LED light source positioned nearest to margins of the lateral face receives at least one maximum current of the adjustable currents.

18. The method of claim 17, wherein the adjustable currents received by the LED light sources are gradually increased along a longitudinal direction from the center to the margins of the lateral face.

19. The method of claim 16, wherein at least one LED light sources positioned nearest to the margins of the lateral face receives at least one of the pulse currents having a maximum duty cycle.

20. The method of claim 19, wherein the LED light sources receive the pulse currents respectively, and the duty cycles of the pulse currents are gradually increased along a longitudinal direction form the center to the margins of the lateral face.

21. A method for operating a side-type backlight module, wherein the side-type backlight module comprises:
a light guide plate comprising a first lateral face, a second lateral face, a third lateral face and a fourth lateral face, the first lateral face being opposite to the second lateral face, the third lateral face being opposite to the fourth lateral face, the first lateral face connected with the third and fourth lateral faces, the second lateral face connected with the third and fourth lateral faces;
a plurality of first LED light sources disposed on the first lateral face;
a plurality of second LED light sources disposed on the second lateral face;
a plurality of third LED light sources disposed on the third lateral face; and
a plurality of fourth LED light sources disposed on the fourth lateral face,
the method for operating the side-type backlight module, comprising:
driving the first, second, third and fourth LED light sources in such a way that powers of first, second, third and fourth LED light sources are varied.

22. The method of claim 21, wherein driving the first, second, third and fourth LED light sources comprises:
generating a plurality of first adjustable currents by means of analog modulation, and inputting the first adjustable currents into the first LED light sources respectively, wherein at least one of the first LED light sources positioned nearest to a center of the first lateral face receives a minimum current of the first adjustable currents;
generating a plurality of second adjustable currents by means of the analog modulation, and inputting the second adjustable currents into the second LED light sources respectively, wherein at least one of the second LED light sources positioned nearest to a center of the second lateral face receives a minimum current of the second adjustable currents;
generating a plurality of third adjustable currents by means of the analog modulation, and inputting the third adjustable currents into the third LED light sources respectively, wherein at least one of the third LED light sources positioned nearest to a center of the third lateral face receives a minimum current of the third adjustable currents; and
generating a plurality of fourth adjustable currents by means of the analog modulation, and inputting the fourth adjustable currents into the fourth LED light sources respectively, wherein at least one of the fourth LED light sources positioned nearest to a center of the fourth lateral face receives a minimum current of the fourth adjustable currents.

23. The method of claim 22, wherein at least one first LED light source positioned nearest to margins of the first lateral face receives at least one maximum current of the first adjustable currents; at least one second LED light source positioned nearest to margins of the second lateral face receives at least one maximum current of the second adjustable currents; at least one third LED light source positioned nearest to margins of the third lateral face receives at least one maximum current of the third adjustable currents; at least one fourth LED light source positioned nearest to margins of the fourth lateral face receives at least one maximum current of the fourth adjustable currents.

24. The method of claim 23, wherein the first adjustable currents received by the first LED light sources are gradually increased from the center to the margins of the first lateral face; the second adjustable currents received by the second LED light sources are gradually increased from the center to the margins of the second lateral face; the third adjustable currents received by the third LED light sources are gradually increased from the center to the margins of the third lateral face; the fourth adjustable currents received by the fourth LED light sources are gradually increased from the center to the margins of the fourth lateral face.

25. The method of claim 21, wherein driving the first, second, third and fourth LED light sources comprise:
generating a plurality of first pulse currents by means of pulse-width modulation, and inputting the first pulse currents into the first LED light sources respectively, peak values of the first pulse currents being substantially equal, wherein each of the first pulse currents has a first duty cycle, and at least one of the first LED light sources positioned nearest to the center of the first lateral face receives at least one of the first pulse currents having a minimum duty cycle of the first duty cycles;
generating a plurality of second pulse currents by means of the pulse-width modulation, and inputting the second pulse currents into the second LED light sources respectively, peak values of the second pulse currents being substantially equal, wherein each of the second pulse currents has a second duty cycle, and at least one of the second LED light sources positioned nearest to the center of the second lateral face receives at least one of the second pulse currents having a minimum duty cycle of the second duty cycles;
generating a plurality of third pulse currents by means of the pulse-width modulation, and inputting the third pulse currents into the third LED light sources respectively, peak values of the third pulse currents being substantially equal, wherein each of the third pulse currents has a third duty cycle, and at least one of the third LED light sources positioned nearest to the center of the third lateral face receives at least one of the third pulse currents having a minimum duty cycle of the third duty cycles; and
generating a plurality of fourth pulse currents by means of the pulse-width modulation, and inputting the fourth pulse currents into the fourth LED light sources respectively, peak values of the fourth pulse currents being substantially equal, wherein each of the fourth pulse currents has a fourth duty cycle, and at least one of the fourth LED light sources positioned nearest to the center of the fourth lateral face receives at least one of the fourth pulse currents having a minimum duty cycle of the fourth duty cycles.

26. The method of claim 25, wherein at least one first LED light source positioned nearest to the margins of the first lateral face receives at least one of the first pulse currents having a maximum duty cycle of the first duty cycles; at least one second LED light source positioned nearest to the margins of the second lateral face receives at least one of the second pulse currents having a maximum duty cycle of the second duty cycles; at least one third LED light source positioned nearest to the margins of the third lateral face receives at least one of the third pulse currents having a maximum duty cycle of the third duty cycles; at least one fourth LED light sources positioned nearest to the margins of the fourth lateral face receives at least one of the fourth pulse currents having a maximum duty cycle of the fourth duty cycles.

27. The method of claim 26, wherein the first LED light sources receives the first pulse currents respectively, and the first duty cycles of the first pulse currents are gradually increased from the center to the margins of the first lateral face; the second LED light sources receives the second pulse currents respectively, and the second duty cycles of the second pulse currents are gradually increased from the center to the margins of the second lateral face; the third LED light sources receives the third pulse currents respectively, and the third duty cycles of the third pulse currents are gradually increased form the center to the margins of the third lateral face; the fourth LED light sources receives the fourth pulse currents respectively, and the fourth duty cycles of the fourth pulse currents are gradually increased from the center to the margins of the fourth lateral face.
